(19) United States
(12) Patent Application Publication
(10) Pub. No.: US 2014/0200066 A1
(43) Pub. Date: Jul. 17, 2014

(54) GAMING SYSTEM HAVING MULTIPLE REEL SETS AND ONE OR MORE ADDITIONAL REELS

(71) Applicant: Misa Enterprises, LLC d/b/a 2 By 2 Gaming, Downers Grove, IL (US)

(72) Inventors: Shridhar P. Joshi, Naperville, IL (US); Alfred Thomas, Las Vegas, NV (US)

(73) Assignee: Misa Enterprises, LLC d/b/a 2 By 2 Gaming, Downers Grove, IL (US)

(21) Appl. No.: 14/154,728

(22) Filed: Jan. 14, 2014

Related U.S. Application Data
(60) Provisional application No. 61/752,968, filed on Jan. 15, 2013.

(51) Int. Cl. G07F 17/34

(52) U.S. Cl. CPC G07F 17/34
USPC 463/20

(57) ABSTRACT

A gaming system for playing a wagering game has a plurality of reel sets and one or more additional reels. The system spins the reel sets and the one or more additional reels to generate an outcome.

### PRIORITY CLAIM

This application is a non-provisional of, and claims the benefit and priority of, U.S. Provisional Patent Application No. 61/752,968, filed on Jan. 15, 2013. The entire contents of such application are hereby incorporated by reference.

### COPYRIGHT NOTICE

A portion of the disclosure of this patent document contains or may contain material which is subject to copyright protection. The copyright owner has no objection to the photocopy reproduction of the patent document in its entirety in exactly the form it appears in the Patent and Trademark Office patent file or records, but otherwise reserves all copyrights whatsoever.

### BACKGROUND

Gaming machines which provide player awards are known. Gaming machines generally have three to five reels and one or more pay lines. Most known gaming machines respond to a player's wager by spinning the reels, coming to a stop and awarding players for the symbols displayed on the pay lines according to a paytable. Introduction of electronics, computers and electronic displays have allowed a continual increase in the variations and complexities of the gaming machines while maintaining the basic concept of traditional machine. Nevertheless, various regulations enforced by the governing bodies effectively restrict the degree of variation which may be incorporated in games played on such gaming machines. Machines and games therefore that offer unique and stimulating variations, yet comply with these restrictions, are eagerly sought by the gaming industry.

One known reel arrangement involves an attempt to increase player interest by causing each of the visible reel positions to display single-symbol independent reels. However, displaying only one symbol on each reel limits the game designer's ability to offer many interesting features like symbol stacking.

One other known reel arrangement involves an attempt to increase player interest by offering multiple reel arrays to play simultaneously. In this method, up to four distinct arrays of traditional rectangular reel arrangements are displayed, and the player can play up to four games simultaneously. The effect is equivalent to playing up to four times faster. However, since all four reel arrays are independent of each other, there is lack of interaction between the various reel arrays. This lack of interaction can result in the loss of player interest and excitement.

There is a need to overcome, or lessen the effects of, the disadvantages, shortcomings and drawbacks described above. There is also a need to increase the excitement and entertainment of the gaming experience for players.

### SUMMARY

In one embodiment, the gaming system, gaming device and method includes a plurality of reel sets. Each of the reel sets has a plurality of reels, such as three or more reels. The system also includes at least one additional or shared reel and a plurality of symbols. The symbols correspond to each one of the reels, and the symbols correspond to the additional or shared reel.

In operation, the system performs the following steps:

(a) displays the reel sets positioned adjacent to each other in the form of a reel set combination, wherein the reel set combination has a plurality of columns of the symbols and a plurality of rows of the symbols;

(b) displays the additional or shared reel adjacent to the reel set combination, wherein the shared reel has a plurality of the symbols, each one of which corresponds with one of the symbols of the plurality of columns or the plurality of rows;

(c) receives a wager input from a player;

(d) spins the reels of each one of the reel sets independent of each other, and spins the shared reel independent of the spinning of the reels of the reel sets;

(e) stops the spinning of the reels of the reel sets and the at least one shared reel;

(f) determines whether a win has occurred based on the symbols displayed on the stopped reels of the reel sets and the shared reel; and

(g) indicates an award in response to the occurrence of the win.

In one embodiment, the gaming system has a group of relatively long additional or shared reels and at least two reel sets. In operation of this embodiment, the system displays a game showing the reel sets stacked vertically next to the group of relatively long shared reels. Each of the pay lines extends across at least one of the additional or shared reels and the reels of at least one of the reel sets.

The gaming system receives a wager input from the player. The system then spins the reels. The system spins each of the reel sets independent of each other. The reels within each reel set are spun independent of each other also. In addition, the system spins each shared reel independent of each other and independent of the reels of the reel sets. The system determines whether a win has occurred based on the game outcome symbols displayed on all of the reel sets and the group of shared reels. The system indicates an award in response to the occurrence of the win.

In one embodiment, the group of shared reels is on the left side, and the reel sets are on the right side such that each of the pay lines begins with the shared reels and ends on the reel set. In another embodiment, the reel sets are on the left side and the shared reels are on the right side such that each of the pay lines begins on the reel sets and ends on the shared reels. In yet another embodiment, the shared reels are positioned between the reel sets such that certain pay lines begin on a reel set, extend across the shared reels and end on another independent reel set.

In yet another embodiment, the shared reels are displayed horizontally and the reel sets are displayed adjacent to each other in a side-by-side fashion to form a horizontally-oriented reel set combination. In such embodiment, the shared reels have the same quantity of symbol columns as the quantity of symbol columns of the horizontally-oriented reel set combination.

In one embodiment, the system's reel arrangement, which combines at least one shared reel and two or more independent reel sets, includes a symbol stacking feature and enables player benefits like interactions across multiple reel sets and additional win opportunities.

In one embodiment, the gaming system has a data storage device including a plurality of computer-readable instructions. The computer-readable instructions are executable to cause a display device to: (i) display a plurality of reel sets, wherein each of the reel sets has a plurality of reels and each of the reels has a plurality of symbols; (ii) display an additional reel, wherein the additional reel has a plurality of the symbols; (iii) display a spinning of the reels and the additional reel after at least one wager input is received; and (iv) display the stopped reels and the stopped additional reel. The gaming system is also operable to determine whether a win has occurred, wherein the determination is based on: (i) the symbols displayed on the stopped reels; and (ii) the symbols displayed on the stopped additional reel.

In one embodiment, the computer-readable instructions are executable to cause the display device to display the reel sets adjacent to the additional reel. In one embodiment, the computer-readable instructions are executable to cause the display device to display a pay line which extends across at least one of the reel sets and also across the additional reel. In one embodiment, the computer-readable instructions are executable to cause the display device to display: (a) a first pay line which extends across a first one of the reel sets and also across the additional reel; and (b) a second pay line which extends across a second one of the reel sets and also across the additional reel. In one embodiment, the reel symbols include a plurality of identical, designated symbols which are displayable by the reels and the additional reel. The computer-readable instructions are executable to determine whether the win has occurred based on: (a) a display of the designated symbol on at least one of the stopped reels; and (b) a display of the designated symbol on the additional reel. In one embodiment, the computer-readable instructions are executable to cause the display device to display a plurality of additional reels, wherein a single pay line is associated with the additional reels and also at least one of the reels. In one embodiment, the reel sets are located to a side of the additional reels. In another embodiment, the reel sets are located below the additional reels. In one embodiment, the gaming system includes the display device, a processor operatively coupled to the display device, and an input device operatively coupled to the processor.

Yet another embodiment includes a method for operating a game. The method includes:

electronically causing a display device to:

(a) display a plurality of reel sets, wherein each of the reel sets has a plurality of reels, and each of the reels has a plurality of symbols;

(b) display an additional reel, wherein the additional reel has a plurality of the symbols;

(c) display a spinning of the reels and the additional reel after at least one wager input is received; and

(d) display the stopped reels and display the stopped additional reel; and electronically determining whether a win has occurred, wherein the determination is based on:

(a) the symbols displayed on the stopped reels; and

(b) the symbols displayed on the stopped additional reel.

Additional features and advantages of the present disclosure are described in, and will be apparent from, the following Detailed Description and the figures.

### BRIEF DESCRIPTION OF THE DRAWINGS

FIG. 1 is a front view of the one embodiment of the gaming system.

FIG. 2 is an enlarged, front view of the display of the embodiment of FIG. 1.

FIG. 3 is a schematic block diagram of one embodiment of the gaming system.

FIG. 4 is a schematic block diagram of the electronic configuration of another embodiment of the gaming system.

FIG. 5 is a table of example pay rules of one embodiment of the gaming system.

FIG. 6 is an enlarged, front view of the embodiment of FIG. 1, illustrating the displayed result of an example winning spin.

FIG. 7 is an enlarged, front view of the embodiment of FIG. 1, illustrating the displayed result of an example winning spin involving scatter pay awards.

FIG. 8 is an enlarged, front view of the display of another embodiment of the gaming system.

FIG. 9 is an enlarged, front view of the display of another embodiment of the gaming system.

FIG. 10 is an enlarged, front view of the display of another embodiment of the gaming system.

FIG. 11 is a front view of one embodiment of the gaming system illustrating at least one reel set having nine independently spinnable reels, where each such reel, when stopped, displays only a single reel symbol.

FIG. 12 is a front view of a reel strip and a display area or window which reveals only a single reel symbol when the reel is stopped.

### DETAILED DESCRIPTION

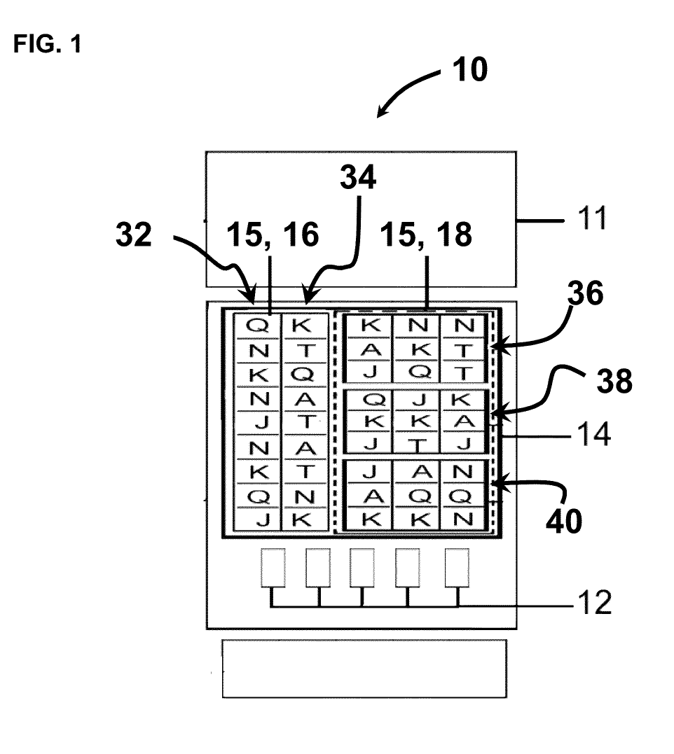

In the one embodiment illustrated in FIG. 1, the gaming device or gaming system 10 includes of a top display area 11 which generally displays the name and pay rules of the game, a button area 12 enabling the player to provide inputs and interact with the game, and a window or reel array display area 14. The reel array display area 14 displays the outcome of the game to the player. The gaming system 10 includes a plurality of rotatable or spinnable reels 15 in video, virtual, electro-mechanical or mechanical form. Each reel 15 includes, or is associated with, a reel strip of symbols. In the example shown in FIG. 1, the reel array display area 14 displays two shared reels or shared reel group 16 and three reel sets 18.

Depending upon the embodiment, the gaming system 10 can be incorporated into, or accessible through use of, a personal computer, a mobile phone, slot machine, gaming device or other electronic data processing device. In one embodiment, the gaming system 10 is stored on a webserver, and the gaming system 10 is accessible online via Internet access devices without the need for any additional hardware.

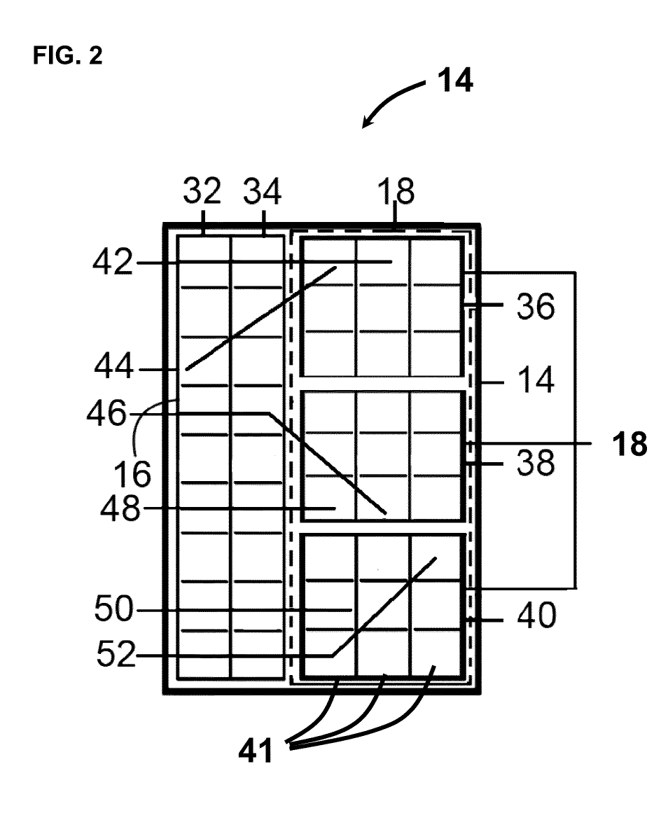

FIG. 2 illustrates one embodiment of the reel array display area 14, which includes shared reel group 16 and a reel set combination 18 in a front view. In one embodiment, the shared reel group 16 includes additional or shared reels 32 and 34. The reel set combination 18 includes reel sets 36, 38 and 40. Each of the additional or shared reels 32 and 34 is relatively long or tall, and the shared reels 32 and 34 spin independently of each other.

Each of the reel sets 36, 38 and 40 has a plurality of reels. In the embodiment illustrated, each reel set has three reels 41 arranged vertically in side-by-side fashion. In each reel set, the reels 41 spin independently of each other. In one embodiment, this reel arrangement includes a variety of pay lines, such as pay lines 42, 44, 46, 48, 50 and 52, on which a player can win an award.

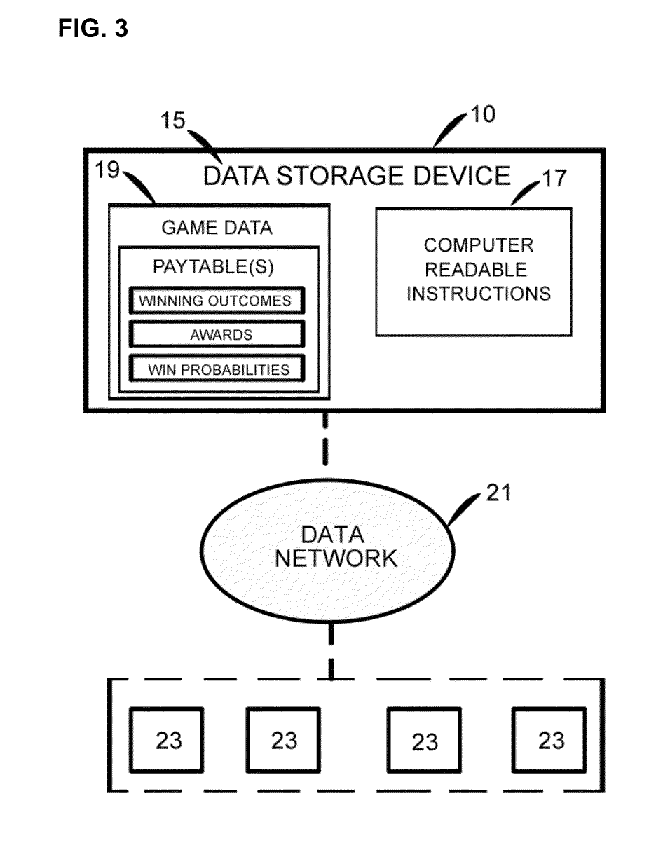

In one embodiment illustrated in FIG. 3, the gaming system 10 includes a data storage device 15. The data storage device 15 includes a plurality of computer-readable instructions 17 and game data 19. The game data 19, in one embodiment, includes one or more paytables, including winning outcomes, awards and win probabilities. In one embodiment, the data storage device 15 includes a server operatively coupled to a data network 21, such as the Internet, wide area network or local area network. The network 21 is accessible to a plurality of network access devices 23 through a wire-based or wireless connection. The network access devices 23 have display devices and input devices for use by players.

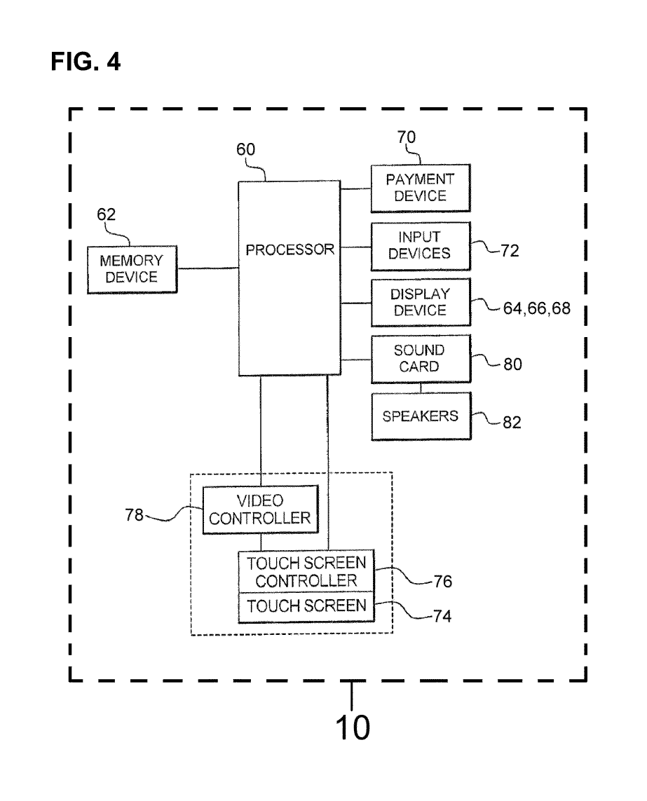

In one embodiment illustrated in FIG. 4, the gaming system 10 includes at least one processor 60 in communication with a memory device 62. The memory device 62 stores program code and instructions, executable by the processor 60 to control the gaming system 10. The embodiment shown includes at least one or more display devices 64, 66 and 68, and at least one payment acceptance device 70 which could be a hardware device, program code or any other method of monetary transaction. In one embodiment, the system 10 also includes a sound card 80 and speakers 82 as well as a video controller 78 to communicate with the various displays. In one embodiment, the gaming system 10 also has additional input devices 72, including, but not limited to, multiple buttons, a keyboard and mouse as well as a touch screen 74 which communicates with a touch screen controller 76.

In one embodiment, the data storage device 15 and memory device 62 are tangible, non-transitory computer-readable storage mediums. Such a storage medium may take many forms, including, but not limited to, non-volatile media and volatile media. Non-volatile media include, for example, optical or magnetic disks, flash drives, or any of the storage devices operating within a computer or server. Common forms of non-transitory computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, or any other medium from which a computer can read programming code and/or data. Many of these forms of computer readable media may be involved in carrying one or more sequences of one or more instructions to a processor for execution. Volatile media include dynamic memory, such as main memory of such a computer or server.

In contrast to non-transitory mediums, transitory physical transmission media include coaxial cables, copper wire and fiber optics, including the wires that comprise a bus within a computer system, a carrier wave transporting data or instructions, and cables or links transporting such a carrier wave. Carrier-wave transmission media can take the form of electric or electromagnetic signals, or acoustic or light waves such as those generated during radio frequency (RF) and infrared (IR) data communications.

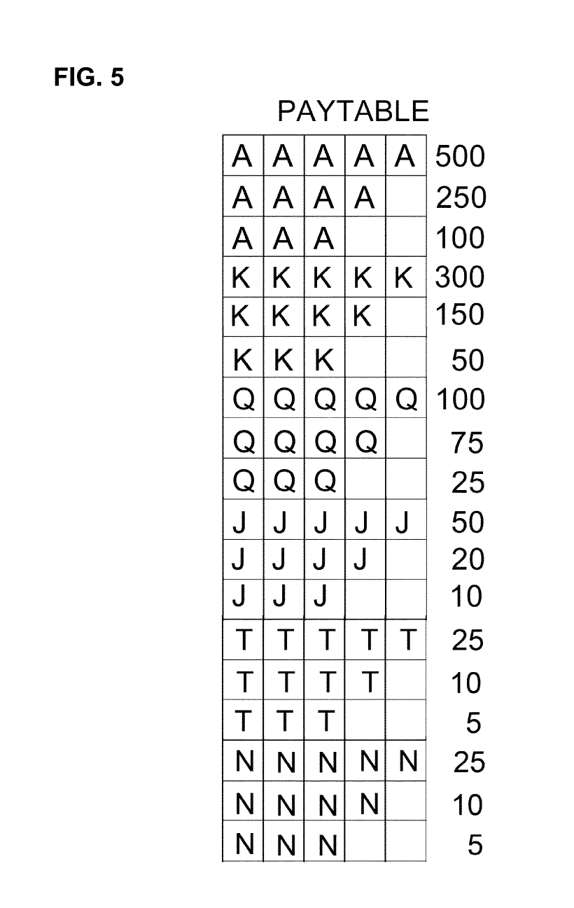

FIG. 5 illustrates an example of one embodiment of the pay rules for the gaming system 10. In this example, the illustrated symbol combinations correspond to designated combinations of symbols which can extend from shared reel 32, through the shared reel 34, and through one or more of reels 41 of reel set 36, 38 or 40. After the reels stop spinning, the final positions of the game outcome symbols displayed on the reels might match one of the pay rules creating a win. In such event, the player is awarded the amount specified by that pay rule. If a player wins on multiple pay lines, additional amounts could be awarded consistent with the pay rules. It should be understood that symbol combinations and associated awards shown in FIG. 5 are merely examples, and any suitable paytable may be implemented for the gaming system 10.

In one embodiment of the operation of the gaming system 10, the player makes a payment to place the wager on the game and uses one of the available inputs to start the game. In response to the game start command, the computer processor 60 picks one or more random symbol stopping positions for the game according to the program code 17 using a random number generator. The processor 60 causes the reels to spin, come to a stop and display the selected symbol stopping positions on the reels. At the conclusion of the spin, the processor 60 evaluates the resulting symbol positions, compares them with the pay rules of the game, displays winning pay lines, if any, and awards the appropriate win amount, if any, to the player.

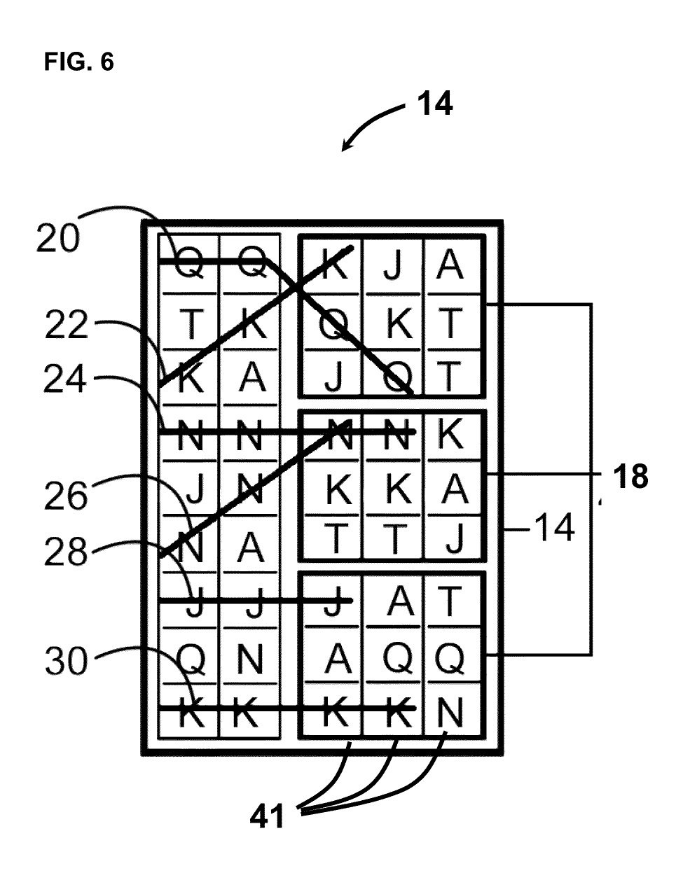

FIG. 6 illustrates one embodiment of the reel array 14, displaying the result of a winning spin. The player has won with symbol K on pay lines 22 and 30, with symbol Q on pay line 20, with symbol J on pay line 28, and with symbol N on pay lines 24 and 26, and the player will be awarded 300 credits based on the pay rules of the game as illustrated in FIG. 5.

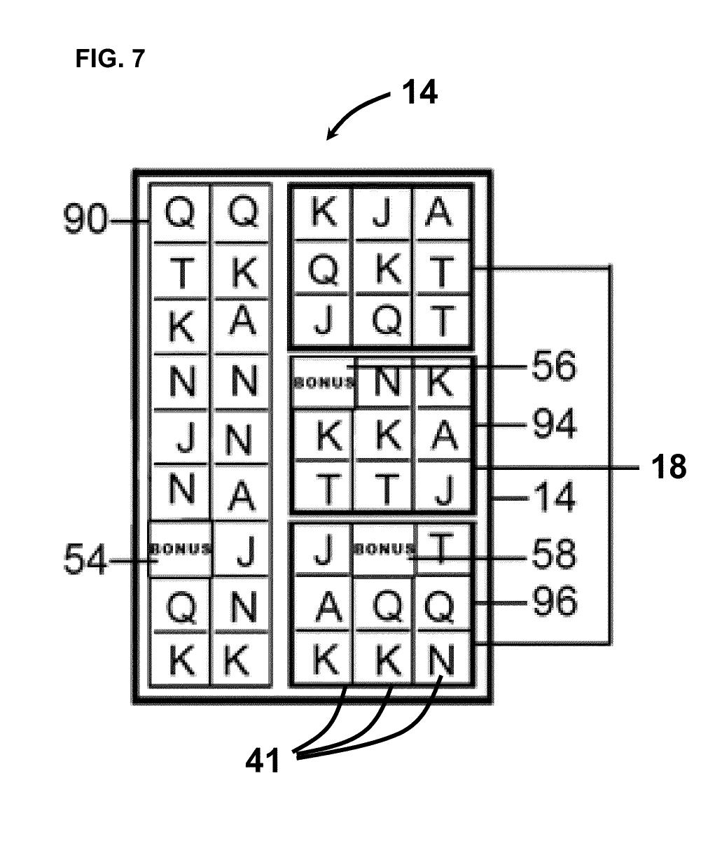

FIG. 7 illustrates an example of one embodiment of the reel array 14 illustrating a win outcome based on scatter pays. In this example, the player has won the scatter pay awards with the bonus symbol 54 on one of the shared reels 90, and bonus symbols 56 and 58 on the reel sets 94 and 96. In this embodiment, scatter awards include a free spin bonus round which will be played on the entire reel array 14, even though the scatter award was won on only two of the three reel sets.

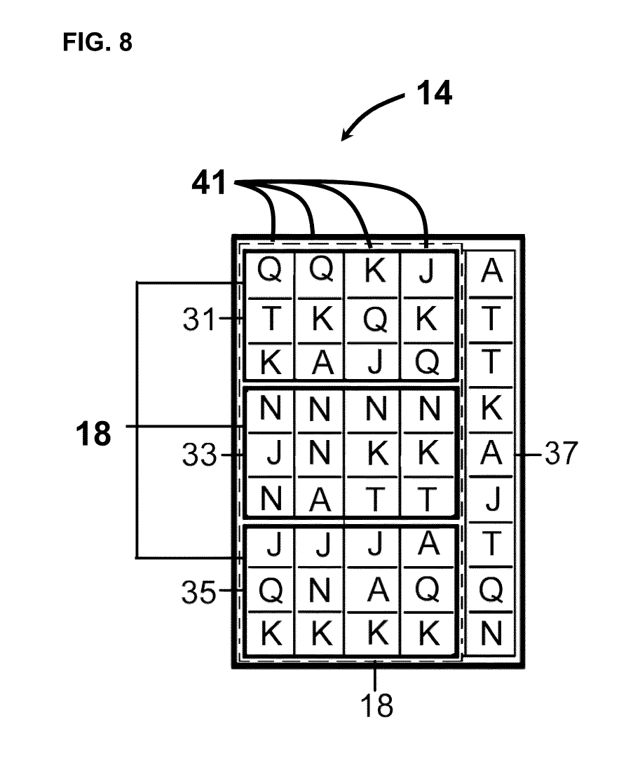

FIG. 8 illustrates another embodiment of the gaming system 10 with shared reel 37 and reel sets 31, 33 and 35, which form the reel set combination 18. In this embodiment, the shared reel 37 is located to the right of the reel set combination 18, and each reel set includes four independently spinnable reels 41.

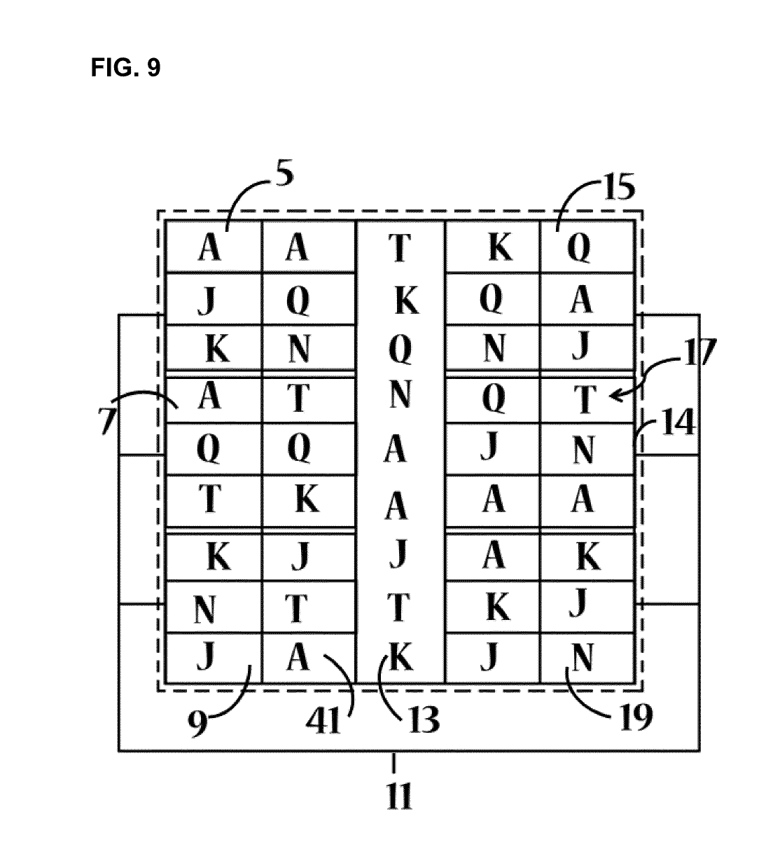

FIG. 9 illustrates another embodiment of the gaming system 10 with central, shared reel 13 and reel sets 5, 7, 9, 15, 17 and 19 which form the reel set combination 11. In this embodiment, the central, shared reel 13 is located in the middle with reel sets 5, 7 and 9 on the one side and reel sets 15, 17 and 19 on the other side, and each reel set includes two independently spinnable reels 41.

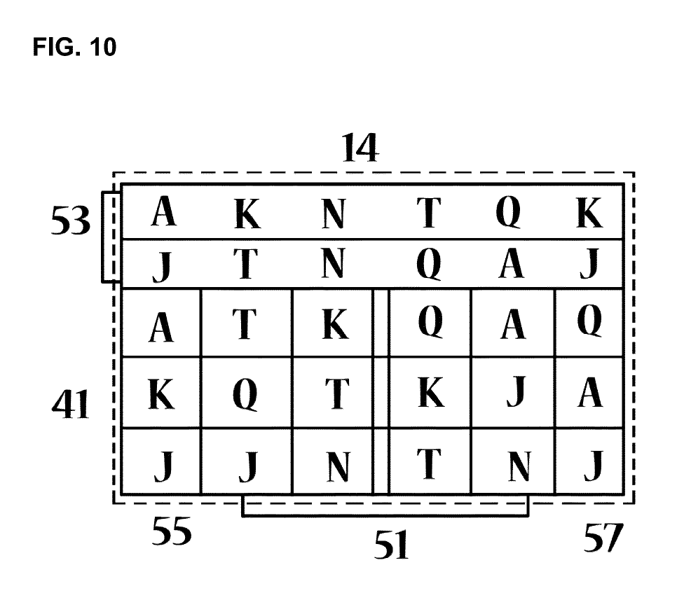

FIG. 10 illustrates another embodiment of the gaming system 10 with two shared reels 53 and reel sets 55 and 57, which form the reel set combination 51. In this embodiment, the shared reels 53 are located horizontally on top of the reel set combination 51, and each reel set includes three independently spinnable reels 41. In one embodiment, the shared reels 53 spin or rotate about a common axis causing a horizontal symbol movement. In such embodiment, the reels of reel sets 55 and 57 rotate about a different axis causing a vertical symbol movement.

Depending upon the embodiment, the reels of the gaming system 10 can start and stop at different times. In one embodiment, all of the reels (including all reels 41 and all shared reels) start spinning at the same time and stop spinning at the same time. In another embodiment, designated reels start and stop spinning at different times. For example, at the start, the reels 41 and one shared reel spin and come to a stop. Afterwards, the other shared reel spins and comes to a stop. In another embodiment, designated reels spin in different directions. For example, shared reels spin horizontally whereas all reels 41 of the reel sets spin vertically.

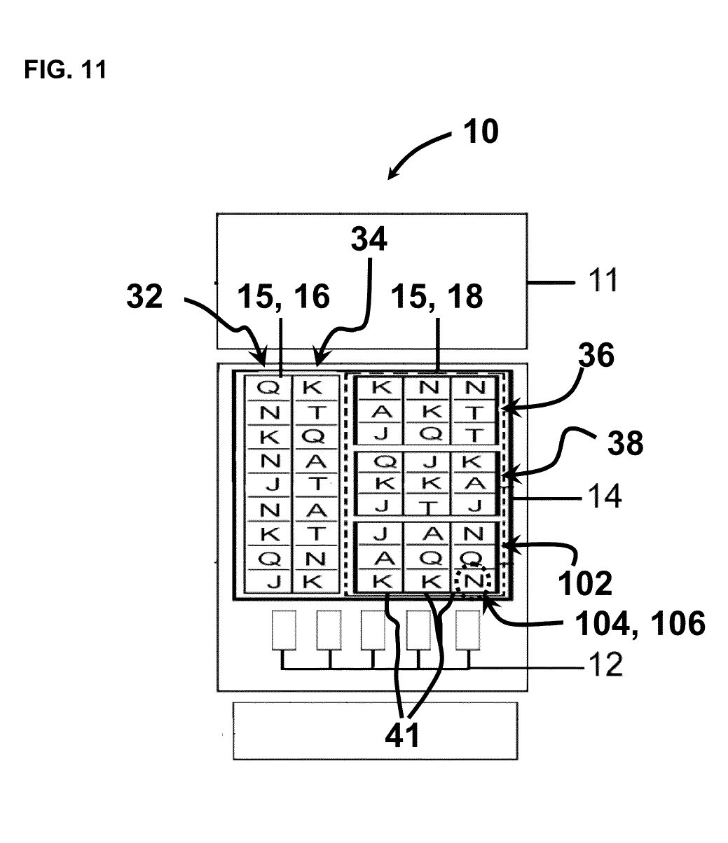

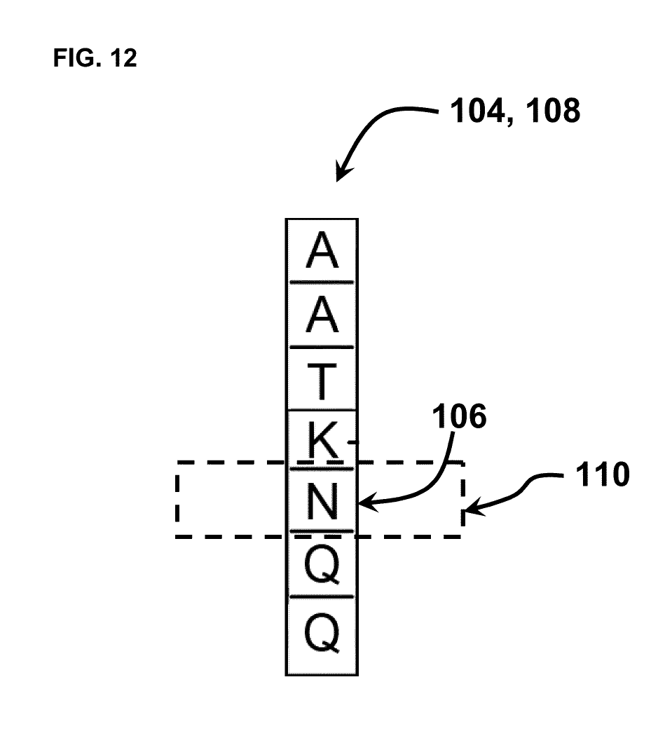

In one embodiment illustrated in FIG. 11, one of more of the reel sets 36, 38 and 40 has a matrix or grid of independently rotatable reels. In an example of this embodiment, reel set 102 displays nine independently rotatable reels. Each of the nine reels, when stopped, displays a single symbol. In the example shown, reel 104, which has stopped spinning, displays one of its symbols, symbol N 106. As illustrated in FIG. 12, the reel 104 has a reel strip 108 which includes the symbol 106. As shown, the reel 104 has a display zone, area or window 110. The window 110 enables visibility of the any symbol which may stop within the window 110. At the same time, the window 110 masks the symbols A, A, T, K, Q and Q which, in this example, are not at such position.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A gaming system comprising:
a data storage device comprising a plurality of computer-readable instructions, the computer-readable instructions being executable to:
(a) cause a display device to:
(i) display a plurality of reel sets, each of the reel sets comprising a plurality of reels, each of the reels comprising a plurality of symbols;
(ii) display an additional reel, the additional reel comprising a plurality of the symbols;
(iii) display a spinning of the reels and the additional reel after at least one wager input is received; and
(iv) display the reels and the additional reel stopped; and
(b) determine whether a win has occurred, the determination being based on:
(i) the symbols displayed on the stopped reels; and
(ii) the symbols displayed on the stopped additional reel.

2. The gaming system of claim 1, wherein the computer-readable instructions are executable to cause the display device to display the reel sets adjacent to the additional reel.

3. The gaming system of claim 1, wherein the computer-readable instructions are executable to cause the display device to display a pay line which extends across at least one of the reel sets and also across the additional reel.

4. The gaming system of claim 1, wherein the computer-readable instructions are executable to cause the display device to display: (a) a first pay line which extends across a first one of the reel sets and also across the additional reel; and (b) a second pay line which extends across a second one of the reel sets and also across the additional reel.

5. The gaming system of claim 1, wherein the symbols comprise a plurality of identical, designated symbols which are displayable by the reels and the additional reel, the computer-readable instructions being executable to determine whether the win has occurred based on: (a) a display of the designated symbol on at least one of the stopped reels; and (b) a display of the designated symbol on the additional reel.

6. The gaming system of claim 1, wherein the computer-readable instructions are executable to cause the display device to display a plurality of additional reels, wherein a single pay line is associated with the additional reels and also at least one of the reels.

7. The gaming system of claim 6, wherein the reel sets are located to a side of the additional reels.

8. The gaming system of claim 6, wherein the reel sets are located below the additional reels.

9. The gaming system of claim 1, which comprises the display device, a processor operatively coupled to the display device, and an input device operatively coupled to the processor.

10. A gaming system comprising:
a data storage device accessible by a processor, the data storage device storing:
(a) data associated with:
(i) a plurality of reel sets, each of the reel sets having a plurality of reels;
(ii) at least one shared reel;
(iii) a plurality of symbols including symbols corresponding to each one of the reels and symbols corresponding to the at least one shared reel;
(b) a plurality of instructions which are readable to cause the processor to operate with a display device and an input device to:
(i) display the reel sets positioned adjacent to each other in form of a reel set combination, wherein the reel set combination has a plurality of columns of the symbols and a plurality of rows of the symbols;
(ii) display the at least one shared reel adjacent to the reel set combination, wherein the at least one shared reel has a plurality of the symbols;
(iii) receive a wager input;
(iv) spin the reels of each one of the reel sets independent of each other, and spin the at least one shared reel independent of the spinning of the reels of the reel sets;
(v) stop the spinning of the reels of the reel sets and the at least one shared reel;
(vi) determine whether a win has occurred based on the symbols displayed on the stopped reels of the reel sets and the shared reel; and
(vii) indicate an award in response to the occurrence of the win.

11. The gaming system of claim 10, wherein the data storage device includes data associated with a plurality of shared reels.

12. The gaming system of claim 11, wherein the plurality of shared reels form multiple columns, and the display device displays a randomly selected outcome indicated by the symbols aligned along a pay line extending through the symbols displayed on the shared reels and at least one of the plurality of symbols displayed on at least one of the reels of at least one of the reel sets.

13. The gaming system of claim 11, wherein the plurality of shared reels form a first group of columns, and the display device displays a randomly selected outcome indicated by the symbols aligned along a pay line extending through the symbols displayed on at least one of the shared reels and at least one of the plurality of symbols displayed on at least one of the reels of at least one of the reel sets.

14. The gaming system of claim 11, wherein the plurality of shared reels include two reels and the plurality of reel sets include three sets of reels, stacked one below another, forming five columns and nine rows.

15. The gaming system of claim 12, wherein each one of the aligned symbols is selected from the group consisting of: (a) the symbols of the plurality of columns; or (b) the symbols of the plurality of rows.

16. The gaming system of claim 10, wherein each one of the reels wherein a plurality of the instructions are readable to cause the processor to operate with the display device to display only a single one of the symbols corresponding to at least one of the reels after the reel stops spinning.

17. A method for operating a game, the method comprising:
electronically causing a display device to:
(a) display a plurality of reel sets, each of the reel sets comprising a plurality of reels, each of the reels comprising a plurality of symbols;
(b) display an additional reel, the additional reel comprising a plurality of the symbols;
(c) display a spinning of the reels and the additional reel after at least one wager input is received; and
(d) display the stopped reels and the stopped additional reel; and
electronically determining whether a win has occurred, the determination being based on:
(a) the symbols displayed on the stopped reels; and
(b) the symbols displayed on the stopped additional reel.

18. The method of claim 17, which comprises causing the display device to display the reel sets adjacent to the additional reel.

19. The method of claim 17, which comprises causing the display device to display a pay line which extends across at least one of the reel sets and also across the additional reel.

20. The method of claim 17, which comprises causing the display device to display: (a) a first pay line which extends across a first one of the reel sets and also across the additional reel; and (b) a second pay line which extends across a second one of the reel sets and also across a second, additional reel.
